(19) United States
(12) Patent Application Publication
(10) Pub. No.: US 2026/0056298 A1
(43) Pub. Date: Feb. 26, 2026

(54) DISTANCE MEASUREMENT DEVICE

(71) Applicant: HAMAMATSU PHOTONICS K.K., Hamamatsu-shi, Shizuoka (JP)

(72) Inventors: Keisuke UCHIDA, Hamamatsu-shi, Shizuoka (JP); Munenori TAKUMI, Hamamatsu-shi, Shizuoka (JP)

(73) Assignee: HAMAMATSU PHOTONICS K.K., Hamamatsu-shi, Shiauoka (JP)

(21) Appl. No.: 19/102,945

(22) PCT Filed: Jun. 22, 2023
(86) PCT No.: PCT/JP2023/023201

§ 371 Date: Feb. 11, 2025

(30) Foreign Application Priority Data
Aug. 25, 2022 (JP) 2022-133896

(51) Int. Cl. G01S 7/4863; G01S 7/4865; G01S 7/487; G01S 17/10; G01S 17/894

(52) U.S. Cl. CPC G01S 7/4863; G01S 7/4865; G01S 7/487; G01S 17/10; G01S 17/894

(57) ABSTRACT

A distance measurement apparatus includes a light source, a light receiving unit, a control unit, and a processing unit. The light receiving unit includes a photodiode, and a charge accumulation portion for accumulating charges generated in the photodiode. The control unit applies, to the light receiving unit, a control pattern including M frames indicating whether or not to accumulate the charges in each of N periods. When the control pattern is represented by a matrix of M rows and N columns, and a value of an element at an m-th row and an n-th column is set to 1 when charge accumulation is indicated in an n-th period in an m-th frame, and is set to 0 when non-accumulation is indicated, conditions that a Hamming distance is 1 for all combinations of two column vectors adjacent to each other and the like are satisfied.

### TECHNICAL FIELD

The present disclosure relates to an apparatus and a method for measuring a distance to an object by using a time of flight method.

### BACKGROUND ART

A distance measurement technique by using a time of flight (TOF) method measures a distance to an object by obtaining a time until a light pulse output from a light source is reflected by the object and returns to a light receiving unit. As a method of distance measurement by the TOF method, a 2-phase method and a phase shift method are known, and further, a method by using a compressive sensing technique is also known (Patent Document 1, Non Patent Document 1). In each of the above methods, a distance measurement apparatus includes the light source for irradiating the object with the light pulse, and the light receiving unit including a photodiode and a charge accumulation portion.

In the distance measurement technique by using the 2-phase method, the object is irradiated with the light pulse having a pulse width T output from the light source, and out of charges generated in the photodiode which receives the light pulse reflected by the object, the charges generated in a first period of the same time T as the pulse width are accumulated in one charge accumulation portion, and the charges generated in a subsequent second period of the time T are accumulated in another charge accumulation portion. Further, based on a ratio of the amounts of the charges accumulated by the above two charge accumulation portions, the time from a light pulse output timing by the light source to a light pulse receiving timing by the photodiode is calculated to determine the distance to the object.

In the distance measurement technique by using the 2-phase method, in order to increase a measurable distance, it is necessary to increase the pulse width of the light pulse and the time of the charge accumulation period, and thus, the measurable distance and a distance resolution are in a trade-off relationship.

In the distance measurement technique by using the phase shift method, the object is irradiated with the light pulse having the pulse width T output from the light source, and out of the charges generated in the photodiode which receives the light pulse reflected by the object, the charges generated in a first period of the same time T as the pulse width are accumulated in a charge accumulation portion. Next, in a second period of the time T subsequent to the first period, the charges are accumulated in the same manner. Thereafter, the charges are similarly accumulated in an n-th period of the time T subsequent to an (n−1)-th period.

As described above, the charge accumulation period is shifted by the time T, and the charges generated in the photodiode are accumulated in each of a plurality of periods divided by the time T. Further, based on the amount of the charges accumulated in each of the plurality of periods, the time from the light pulse output timing by the light source to the light pulse receiving timing by the photodiode is calculated to determine the distance to the object.

In the distance measurement technique by using the phase shift method, the measurable distance can be increased without decreasing the distance resolution by increasing the number of periods divided by the time T. However, when the number of periods divided by the time T increases, the number of measurements also increases.

The distance measurement technique by using the compressive sensing technique is based on the fact that a reflected light intensity as a function of the time has sparsity because the reflected light pulse appears in a limited period after the light pulse output timing of the light source, and the reflected light does not exist in other time periods. That is, after the light pulse output timing of the light source, the charges generated in the photodiode are accumulated in the charge accumulation portion in one or a plurality of periods according to a random frame pattern. Further, the distance to the object is determined by using the compressive sensing technique based on the amount of the charges accumulated in the charge accumulation portion for each of the plurality of frame patterns different from each other.

As compared with the 2-phase method, the distance measurement technique by using the compressive sensing technique can increase the measurable distance without decreasing the distance resolution. Further, as compared with the phase shift method, the distance measurement technique by using the compressive sensing technique can measure the distance to the object with the smaller number of measurements. The distance measurement technique by using the compressive sensing technique may be regarded as a high-speed or high-performance version of the distance measurement technique by using the phase shift method.

### CITATION LIST

### Patent Literature

Patent Document 1: International Publication No. 2016/133053

### Non Patent Literature

Non Patent Document 1: Keiichiro Kagawa, et al., “A Dual-Mode 303-Megaframes-per-Second Charge-Domain Time-Compressive Computational CMOS Image Sensor”, Sensors, 22 (5), 1953, pp. 1-16, 2022
Non Patent Document 2: Joel A. Tropp, et al., “Signal Recovery From Random Measurements Via Orthogonal Matching Pursuit”, IEEE TRANSACTIONS ON INFORMATION THEORY, Vol. 53, No. 12, pp. 4655-4666, 2007

### SUMMARY OF INVENTION

### Technical Problem

In the process of studying the distance measurement technique by using the compressive sensing technique, the present inventors have found that the above technique has the following problems. That is, the distance to the object may not be determined depending on a pattern indicating a period in which the charges generated in the photodiode are accumulated in the charge accumulation portion. Further, it may not be easy to find a pattern which can determine the distance to the object.

An object of an embodiment is to provide an apparatus and a method capable of reliably performing distance measurement by a TOF method using a compressive sensing technique.

### Solution to Problem

An embodiment is a distance measurement apparatus. The distance measurement apparatus includes (1) a light source for irradiating an object with a light pulse having a pulse width P; (2) a light receiving unit including a photodiode for receiving the light pulse with which the object is irradiated from the light source and reflected by the object to generate charges, and a charge accumulation portion for accumulating the charges generated in the photodiode; (3) a control unit for applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing unit for determining a distance to the object by using a compressive sensing technique based on an amount of the charges accumulated by the charge accumulation portion, and the apparatus is configured to measure the distance to the object by using a time of flight method, the pulse width P is set to the predetermined time T or less, and in the control unit, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, and a Hamming distance is 1 for all combinations of two column vectors adjacent to each other out of the N column vectors, is applied to the light receiving unit.

An embodiment is a distance measurement apparatus. The distance measurement apparatus includes (1) a light source for irradiating an object with a light pulse having a pulse width P; (2) a light receiving unit including a photodiode for receiving the light pulse with which the object is irradiated from the light source and reflected by the object to generate charges, and a charge accumulation portion for accumulating the charges generated in the photodiode; (3) a control unit for applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing unit for determining a distance to the object by using a compressive sensing technique based on an amount of the charges accumulated by the charge accumulation portion, and the apparatus is configured to measure the distance to the object by using a time of flight method, the pulse width P is set to more than k−1 times and k times or less the predetermined time T (k is an integer of 2 or more), and in the control unit, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, a Hamming distance is 1 for all combinations of two column vectors adjacent to each other out of the N column vectors, a Hamming distance is k or more for all combinations of two column vectors separated from each other by k+1 columns out of the N column vectors, and for all combinations of consecutive k+1 column vectors out of the N column vectors, in a matrix of M rows and k+1 columns formed by the k+1 column vectors, there are k+1 or more row vectors different from each other and in which a value of at least one element is 1 out of M row vectors, is applied to the light receiving unit.

An embodiment is a distance measurement method. The distance measurement method is a method using (1) a light source for irradiating an object with a light pulse having a pulse width P; and (2) a light receiving unit including a photodiode for receiving the light pulse with which the object is irradiated from the light source and reflected by the object to generate charges, and a charge accumulation portion for accumulating the charges generated in the photodiode, the method for measuring a distance to the object by using a time of flight method, and the method includes (3) a control step of applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing step of determining the distance to the object by using a compressive sensing technique based on an amount of the charges accumulated by the charge accumulation portion, and the pulse width P is set to the predetermined time T or less, and in the control step, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, and a Hamming distance is 1 for all combinations of two column vectors adjacent to each other out of the N column vectors, is applied to the light receiving unit.

An embodiment is a distance measurement method. The distance measurement method is a method using (1) a light source for irradiating an object with a light pulse having a pulse width P; and (2) a light receiving unit including a photodiode for receiving the light pulse with which the object is irradiated from the light source and reflected by the object to generate charges, and a charge accumulation portion for accumulating the charges generated in the photodiode, the method for measuring a distance to the object by using a time of flight method, and the method includes (3) a control step of applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing step of determining the distance to the object by using a compressive sensing technique based on an amount of the charges accumulated by the charge accumulation portion, and the pulse width P is set to more than k−1 times and k times or less the predetermined time T (k is an integer of 2 or more), and in the control step, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, a Hamming distance is 1 for all combinations of two column vectors adjacent to each other out of the N column vectors, a Hamming distance is k or more for all combinations of two column vectors separated from each other by k+1 columns out of the N column vectors, and for all combinations of consecutive k+1 column vectors out of the N column vectors, in a matrix of M rows and k+1 columns formed by the k+1 column vectors, there are k+1 or more row vectors different from each other and in which a value of at least one element is 1 out of M row vectors, is applied to the light receiving unit.

### Advantageous Effects of Invention

According to the distance measurement apparatus and the distance measurement method of the embodiments, it is possible to reliably perform distance measurement by a TOF method using a compressive sensing technique.

### BRIEF DESCRIPTION OF DRAWINGS

FIG. 1 is a diagram illustrating a configuration of a distance measurement apparatus 1.

FIG. 2 includes diagrams schematically illustrating a configuration of a light receiving unit 5 of the distance measurement apparatus 1, and includes (a) a diagram illustrating a circuit configuration of the light receiving unit 5, and (b) a diagram schematically illustrating a state in which, when switches SW1, SW3, and SW4 are in an OFF state and a switch SW2 is in an ON state, charges generated in a photodiode PD are transferred to a second charge accumulation portion C2 through the switch SW2.

FIG. 3 is a diagram illustrating a control pattern of a comparative example.

FIG. 4 is a diagram illustrating the control pattern in a waveform format in the case in which M=3 and N=7.

FIG. 5 is a diagram illustrating the control pattern in a table format in the case in which M=3 and N=7.

FIG. 6 is a diagram illustrating the control pattern in the table format in the case in which M=3 and N=7.

FIG. 7 is a diagram illustrating the control pattern in the table format in the case in which M=3 and N=7.

FIG. 8 is a diagram illustrating the control pattern in the table format in the case in which M=4 and N=15.

FIG. 9 is a diagram illustrating the control pattern in the waveform format in the case in which k=2, M=4, and N=11.

FIG. 10 is a diagram illustrating the control pattern in the table format in the case in which k=2, M=4, and N=11.

FIG. 11 is a diagram illustrating the control pattern in the table format in the case in which k=2, M=4, and N=12.

FIG. 12 is a diagram illustrating the control pattern in the table format in the case in which k=2, M=5, and N=31.

FIG. 13 is a diagram illustrating the control pattern in the table format in the case in which k=3, M=4, and N=7.

FIG. 14 is a diagram illustrating the control pattern in the table format in the case in which k=3, M=6, and N=25.

FIG. 15 is a diagram illustrating the control pattern in the table format in the case in which k=4, M=6, and N=31.

FIG. 16 is a diagram illustrating the control pattern in the waveform format in the case in which the number of charge accumulations rₙ is adjusted.

FIG. 17 is a diagram illustrating the control pattern in the table format in the case in which the number of charge accumulations rₙ is adjusted.

FIG. 18 is a diagram illustrating an example of the control pattern in the case in which a plurality of frames which do not simultaneously indicate charge accumulation in a same period can be simultaneously applied to the light receiving unit 5.

FIG. 19 is a diagram illustrating an example of solving an L0 optimization problem by applying an OMP algorithm.

### DESCRIPTION OF EMBODIMENTS

Hereinafter, embodiments of a distance measurement apparatus and a distance measurement method will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

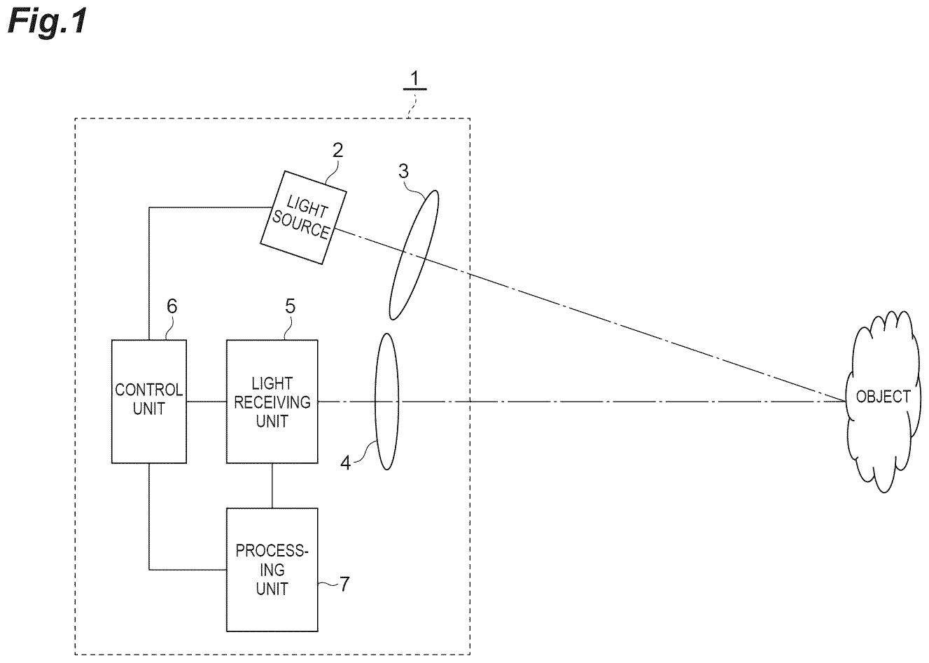

FIG. 1 is a diagram illustrating a configuration of a distance measurement apparatus 1. The distance measurement apparatus 1 is an apparatus for measuring a distance to an object by using a time of flight (TOF) method, and includes a light source 2, an irradiation optical system 3, a focusing optical system 4, a light receiving unit 5, a control unit 6, and a processing unit 7. A distance measurement method is a method of performing a control step and a processing step by using the light source 2, the irradiation optical system 3, the focusing optical system 4, and the light receiving unit 5.

The light source 2 outputs a light pulse with which the object is to be irradiated. The light source 2 outputs the light pulse having a predetermined pulse width P at a predetermined repetition frequency. The light source 2 is arbitrary as long as it can output the light pulse, and is, for example, a laser diode, a light emitting diode, or the like.

The irradiation optical system 3 is an optical system for irradiating the object with the light output from the light source 2. In the case in which the light output from the light source 2 is diverging light, the irradiation optical system 3 efficiently applies the light to the object.

The focusing optical system 4 inputs the light pulse (reflected light pulse) with which the object is irradiated from the light source 2 through the irradiation optical system 3 and reflected by the object, and focuses the reflected light pulse.

The light receiving unit 5 receives the reflected light pulse arriving through the focusing optical system 4. The light receiving unit 5 includes a photodiode for receiving the reflected light pulse to generate charges, and a charge accumulation portion for accumulating the charges generated in the photodiode.

The control unit 6 applies a control pattern to the light receiving unit 5 (the control step). The control pattern is a pattern for indicating whether or not to transfer and accumulate the charges generated in the photodiode of the light receiving unit 5 to the charge accumulation portion in each of N periods divided by a predetermined time T from a light pulse output timing of the light source 2. The control pattern includes M frames, and indicates accumulation/non-accumulation of the charges in each frame and in each period. Each of M and N is an integer of 2 or more.

The processing unit 7 determines a distance to the object by using a compressive sensing technique based on an amount of the charges generated in the photodiode of the light receiving unit 5 and accumulated by the charge accumulation portion (the processing step).

The control unit 6 and the processing unit 7 may be a computer. The control unit 6 and the processing unit 7 include an operation unit (for example, a CPU and the like) for performing a calculation process and the like, a storage unit (for example, a hard disk drive, a RAM, a ROM, and the like) for storing the control pattern, the charge accumulation amount, and the like, a display unit (for example, a liquid crystal display and the like) for displaying the control pattern and the like, an input unit (for example, a keyboard, a mouse, and the like) for receiving an instruction for starting measurement, an input of a measurement condition, and the like, and the like.

The control unit 6 and the processing unit 7 may be not only a computer, but also an application specific integrated circuit (ASIC), a field-programmable gate array (FPGA), or the like.

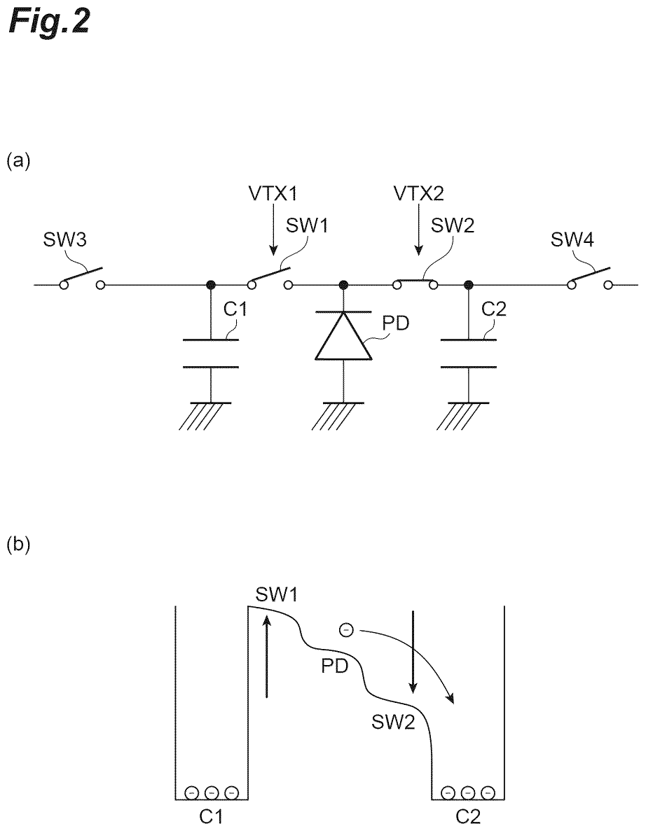

FIG. 2 includes diagrams schematically illustrating a configuration of the light receiving unit 5 of the distance measurement apparatus 1. In this diagram, the light receiving unit 5 has the configuration including two charge accumulation portions. The light receiving unit 5 includes a photodiode PD for generating the charges in response to light receiving, and a first charge accumulation portion C1 and a second charge accumulation portion C2 for accumulating the charges.

Further, the light receiving unit 5 includes a switch SW1 for transferring the charges generated in the photodiode PD to the first charge accumulation portion C1, a switch SW2 for transferring the charges generated in the photodiode PD to the second charge accumulation portion C2, a switch SW3 for outputting the charges accumulated in the first charge accumulation portion C1, and a switch SW4 for outputting the charges accumulated in the second charge accumulation portion C2. The switches SW1 and SW2 are set to any one of an ON state and an OFF state according to values VTX1 and VTX2 of the control pattern which is applied from the control unit 6.
(a) in FIG. 2 illustrates a circuit configuration of the light receiving unit 5. (b) in FIG. 2 schematically illustrates a state in which, when the switches SW1, SW3, and SW4 are in the OFF state and the switch SW2 is in the ON state, the charges generated in the photodiode PD are transferred to the second charge accumulation portion C2 through the switch SW2. When the charge transfer to the second charge accumulation portion C2 is completed, the switch SW2 is set to the OFF state and the switch SW4 is set to the ON state, and the charges accumulated in the second charge accumulation portion C2 are output through the switch SW4.

The number of charge accumulation portions may be set to one, or may be set to two or more. Any one of the plurality of charge accumulation portions may be used as a charge removal portion, or a charge removal portion may be separately provided. The charge removal portion is a portion for accumulating the charges generated in the photodiode PD in a period in which the charge accumulation is not indicated by the control pattern, and it is not necessary to output the above charges. Further, the light receiving unit 5 includes a switch for initializing the charge accumulation in each of the charge accumulation portions and the charge removal portion.

The light receiving unit 5 may be an imaging element in which a plurality of pixels each including the photodiode and the charge accumulation portion are arrayed two-dimensionally on a light receiving surface. In this case, the focusing optical system 4 may be an imaging optical system for inputting and forming an image of the reflected light pulse from the object. The processing unit 7 can acquire a distance image of the object by determining the distance to the object for each of the plurality of pixels. The imaging element in which the plurality of pixels each having the configuration of the light receiving unit 5 as described above are arrayed two-dimensionally is sold as a product “distance area image sensor” from Hamamatsu Photonics K.K.

The distance measurement apparatus and the distance measurement method according to the present embodiment are for measuring the distance to the object by the compressive sensing technique using the light source 2 and the light receiving unit 5 as described above, and have a feature in the control pattern which is applied to the light receiving unit 5 by the control unit 6, and also have a feature in the algorithm of the distance calculation by the processing unit 7. Hereinafter, the control pattern applied to the light receiving unit 5 by the control unit 6 in the control step will be described, and then the contents of the processing performed by the processing unit 7 in the processing step will be described.

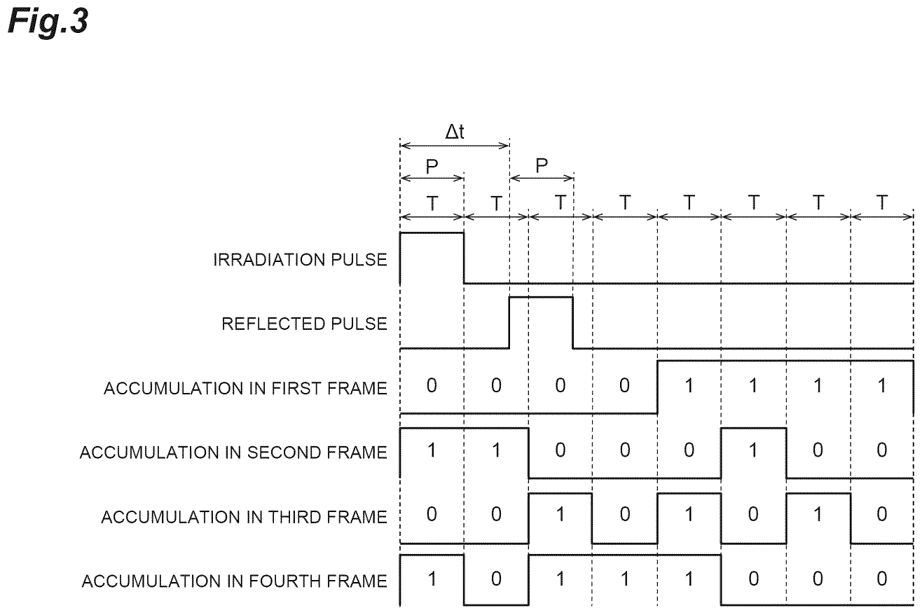

FIG. 3 is a diagram illustrating the control pattern according to a comparative example. In this diagram, in order from the top, a waveform of the irradiation light pulse output from the light source, a waveform of the reflected light pulse reaching the light receiving unit, and patterns of first to fourth frames in the control pattern indicating a period in which the charges generated in the photodiode in the light receiving unit are accumulated in the charge accumulation portion are illustrated. The waveform of the irradiation light pulse and the waveform of the reflected light pulse practically have noise and distortion, but the waveforms are schematically illustrated as rectangles in this diagram (and in subsequent diagrams). Further, it is assumed that one reflected light pulse reaches the light receiving unit for one irradiation light pulse.

A pulse width of each of the irradiation light pulse output from the light source and the reflected light pulse reaching the light receiving unit is set to P. A time of each of a plurality of divided periods after the light pulse output timing of the light source is set to T. In this diagram, it is set to P=T. The control pattern is represented as a pattern in which a value is set to 1 when the accumulation of the charges is indicated in each frame and in each period, and a value is set to 0 when the non-accumulation is indicated.

With respect to the light pulse output timing by the light source, a reflected light pulse arrival timing to the light receiving unit has a time difference Δt according to the distance to the object. By detecting the above time difference Δt, the distance to the object can be determined. In the case of dividing into eight periods after the light pulse output timing of the light source, eight frames are required for the control pattern in the phase shift method. On the other hand, in the case in which the compressive sensing technique is used, as illustrated in FIG. 3, the control pattern may include four frames.

As illustrated in the diagram, the reflected light pulse appears in a limited time period after the light pulse output timing of the light source, and the reflected light does not exist in other time periods, and thus, the reflected light intensity as a function of the time has a sparse property. Therefore, the time from the irradiation light pulse output timing to the reflected light pulse arrival timing can be obtained by using the compressive sensing technique, and further, the distance to the object can be determined. Further, the number of control patterns required in the case in which the compressive sensing technique is used can be made smaller than the number of control patterns required in the case in which the phase shift method is used.

However, in the case in which the distance measurement by using the TOF method is performed by using the compressive sensing technique, the distance to the object may not be determined depending on the pattern indicating the period in which the charges generated in the photodiode are accumulated in the charge accumulation portion. Further, it may not be easy to find the pattern which can determine the distance to the object. In the distance measurement apparatus and the distance measurement method to be described below, the control unit 6 applies the control pattern satisfying the predetermined condition to the light receiving unit 5, and thus, the distance measurement by using the TOF method can be reliably performed by using the compressive sensing technique.

In order to describe the condition to be satisfied by the control pattern, the control pattern is represented by a matrix Φ of M rows and N columns as shown in the following Formula (1). M is the number of frames included in the control pattern. N is the number of periods divided after the light pulse output timing of the light source.

$$[ Formula 1 ]$$

$$Φ = ( \begin{matrix}{a}_{1 , 1} & … {a}_{1 , n} & … {a}_{1 , N} \\ ⋮ & ⋱ & ⋮ \\ {a}_{m , 1} & {a}_{m , n} & {a}_{m , N} \\ ⋮ & & ⋮ \\ {a}_{M , 1} & … {a}_{M , n} & … {a}_{M , N}\end{matrix} ) \qquad ( 1 )$$

A value a_{m,n} of an element at an m-th row and an n-th column of the matrix Φ is set to 1 when the accumulation of the charges in the charge accumulation portion is indicated in an n-th period out of the N periods in an m-th frame out of the M frames, and is set to 0 when the non-accumulation is indicated. In the matrix Φ, a column vector ϕₙ of the n-th column is represented by the following Formula (2). The matrix Φ is formed by the N column vectors ϕ₁ to ϕ_{N} as represented by the following Formula (3).

$$\begin{matrix}[ Formula 2 ] & \\ {ϕ}_{n} = ( \begin{matrix}{a}_{1 , n} \\ ⋮ \\ {a}_{m , n} \\ ⋮ \\ {a}_{M , n}\end{matrix} ) & ( 2 )\end{matrix}$$

$$\begin{matrix}[ Formula 3 ] & \\ Φ = ( {ϕ}_{1} … {ϕ}_{n} … {ϕ}_{N} ) & ( 3 )\end{matrix}$$

The condition to be satisfied by the control pattern is different depending on a ratio between the pulse width P of the light pulse and the time T of each period. In the case in which the pulse width P is set to the time T or less (P≤T), the control pattern needs to satisfy the following first to third conditions.

The first condition is that the value of at least one element is 1 for all the N column vectors ϕ₁ to ϕ_{N}. That is, the matrix Φ does not include a column vector in which the values of all the elements are 0. This condition is required to obtain information for all the N periods. When the column vector in which the values of all the elements are 0 is included in the matrix Φ, no information can be obtained for the period corresponding to the column vector.

The second condition is that all the N column vectors ϕ₁ to ϕ_{N} are different from each other. That is, the matrix Φ does not include the same column vector. This condition is required to identify the position of the reflected light pulse having the same pulse width P as the time T. When the same column vectors are included in the matrix Φ, the position of the reflected light pulse having the same pulse width P as the time T cannot be identified.

The third condition is that a Hamming distance is 1 for all combinations of two column vectors adjacent to each other out of the N column vectors ϕ₁ to ϕ_{N}. The Hamming distance represents the number of positions at which the values are different from each other when the values of the elements at the same position are compared between the two column vectors. For example, between the two column vectors shown in the following Formula (4), the number of positions at which the values are different from each other is 3, and thus, the Hamming distance is 3. This condition is required to distinguish the position from the other position in the case in which the reflected light pulse extends over the two periods.

$$\begin{matrix}[ Formula 4 ] & \\ ( \begin{matrix}1 \\ 1 \\ 0 \\ 1\end{matrix} ) , ( \begin{matrix}0 \\ 1 \\ 1 \\ 0\end{matrix} ) & ( 4 )\end{matrix}$$

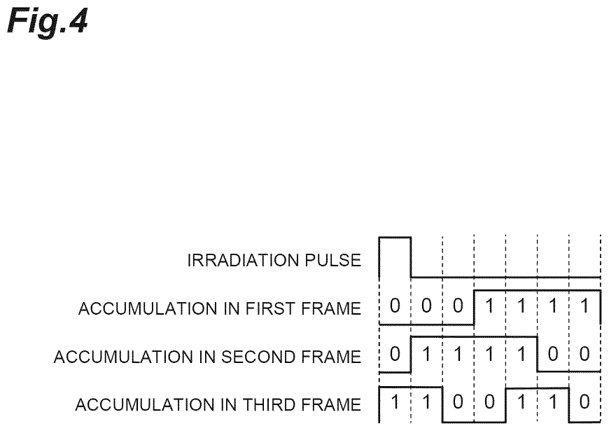

FIG. 4 to FIG. 8 are diagrams illustrating examples of the control pattern which satisfy the first to third conditions in the case in which the pulse width P is set to the time T or less (P≤T).

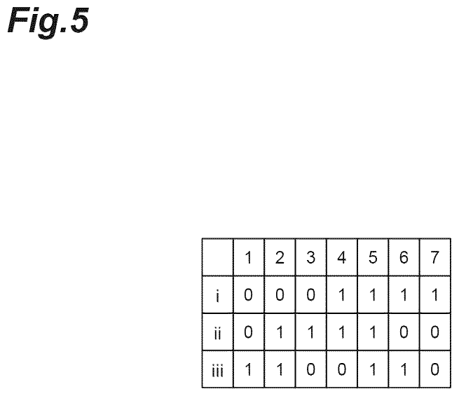

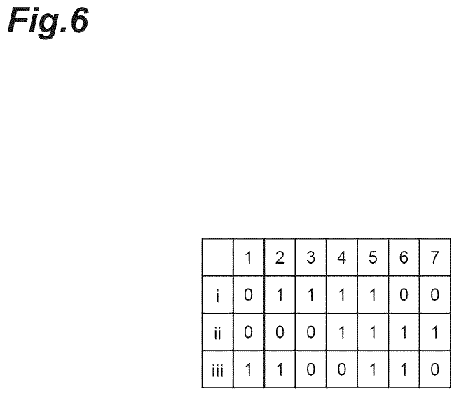

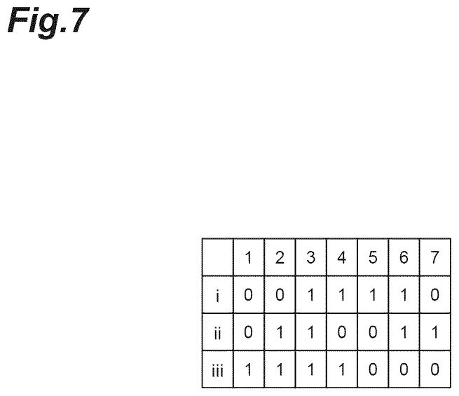

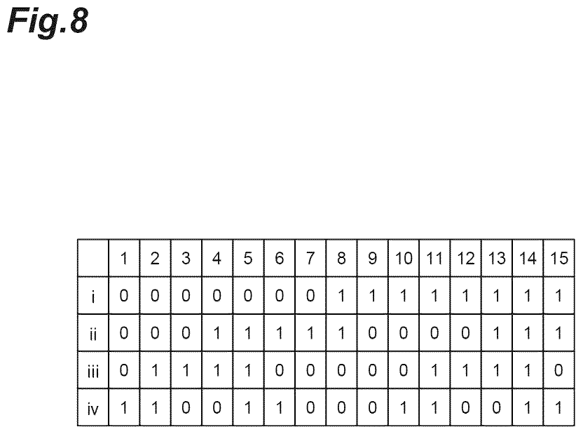

FIG. 4 is a diagram illustrating the control pattern in the waveform format in the case in which M=3 and N=7, with the waveform of the irradiation light pulse output from the light source. FIG. 5 is a diagram illustrating the control pattern in the table format which is illustrated in the waveform format in FIG. 4. Each of FIG. 6 and FIG. 7 is a diagram illustrating the control pattern in the table format in the case in which M=3 and N=7. FIG. 8 is a diagram illustrating the control pattern in the table format in the case in which M=4 and N=15. In the case in which the pulse width P is set to the time T or less (P≤T), there is a relationship of the following Formula (5) between M and N.

$$\begin{matrix}[ Formula 5 ] & \\ N = {2}^{M} - 1 & ( 5 )\end{matrix}$$

In the case in which k is an integer of 2 or more, and the pulse width P is set to more than k−1 times and k times or less the time T ((k−1)T<P≤kT), the control pattern needs to satisfy the following fourth condition and fifth condition in addition to the first to third conditions described above.

The fourth condition is that the Hamming distance is k or more for all combinations of two column vectors separated from each other by k+1 columns out of the N column vectors ϕ₁ to ϕ_{N}. That is, the Hamming distance is k or more for all combinations of the column vector ϕₙ and the column vector ϕₙ₊ₖ₊₁. This condition is required to distinguish in which of the two periods, corresponding to the two column vectors separated from each other by k+1 columns, the reflected light pulse exists.

The fifth condition is that, for all combinations of consecutive k+1 column vectors out of the N column vectors ϕ₁ to ϕ_{N}, in a matrix of M rows and k+1 columns formed by the k+1 column vectors, there are k+1 or more row vectors different from each other and in which the value of at least one element is 1 out of M row vectors.

That is, when the certain consecutive k+1 column vectors are set to ϕₙ to ϕₙ₊ₖ, the matrix of the M rows and the k+1 columns formed by the above k+1 column vectors ϕₙ to ϕₙ₊ₖ is represented by the following Formula (6). Out of the M row vectors included in this matrix, there are k+1 or more row vectors different from each other and in which the value of at least one element is 1. In the case in which the pulse width P of the reflected light pulse is set to kT or less, the reflected light pulse extends over k+1 periods at the maximum, and at least k+1 pieces of information are required to obtain the accumulation charge amount of each of the k+1 periods, and thus, this condition is required.

$$\begin{matrix}[ Formula 6 ] & \\ ( \begin{matrix}{a}_{1 , n} & … & {a}_{1 , n + k} \\ ⋮ & & ⋮ \\ {a}_{m , n} & … & {a}_{m , n + k} \\ ⋮ & & ⋮ \\ {a}_{M , n} & … & {a}_{M , n + k}\end{matrix} ) & ( 6 )\end{matrix}$$

In the case in which k is an integer of 2 or more, and the pulse width P is set to more than k−1 times and k times or less the time T ((k−1)T<P≤kT), it is preferable that the control pattern satisfies the following sixth condition in addition to the first to fifth conditions described above.

The sixth condition is that, for all combinations of consecutive k+1 or less column vectors out of the N column vectors ϕ₁ to ϕ_{N}, a column vector in which a value obtained by dividing an inner product of a sum column vector, which is a sum of the k+1 or less column vectors, and each column vector ϕₙ by a magnitude of the column vector ϕₙ is a maximum value is any one of the k+1 or less column vectors.

That is, when the consecutive k+1 or less column vectors out of the N column vectors ϕ₁ to ϕ_{N} are set to ϕₙ₁ to ϕₙ₂, the sum column vector S_{A} which is the sum of the above column vectors ϕₙ₁ to ϕₙ₂ is represented by the following Formula (7). The calculation of dividing the inner product of the sum column vector S_{A} and each column vector ϕₙ by the magnitude of the column vector ϕₙ is represented by the following Formula (8). The column vector having the maximum calculated value is any one of the column vectors ϕₙ₁ to ϕₙ₂.

$$\begin{matrix}[ Formula 7 ] & \\ {S}_{A} = {\sum }_{n = n 1}^{n 2} {ϕ}_{n} = ( \begin{matrix}{\sum }_{n = n 1}^{n 2} {a}_{1 , n} \\ ⋮ \\ {\sum }_{n = n 1}^{n 2} {a}_{m , n} \\ ⋮ \\ {\sum }_{n = n 1}^{n 2} {a}_{M , n}\end{matrix} ) & ( 7 )\end{matrix}$$

$$\begin{matrix}[ Formula 8 ] & \\ \frac{〈 {ϕ}_{n} , {S}_{A} 〉}{{‖ {ϕ}_{n} ‖}_{2}} & ( 8 )\end{matrix}$$

In the case in which k=2 or k=3, the above sixth condition is automatically satisfied when the other conditions are satisfied. Further, the above sixth condition is necessary in the case in which an orthogonal matching pursuit algorithm (Non Patent Document 2) is used in the distance calculation by the processing unit 7 described later, and in addition, it is not necessary in the case in which another algorithm (for example, a brute force method or the like) is used.

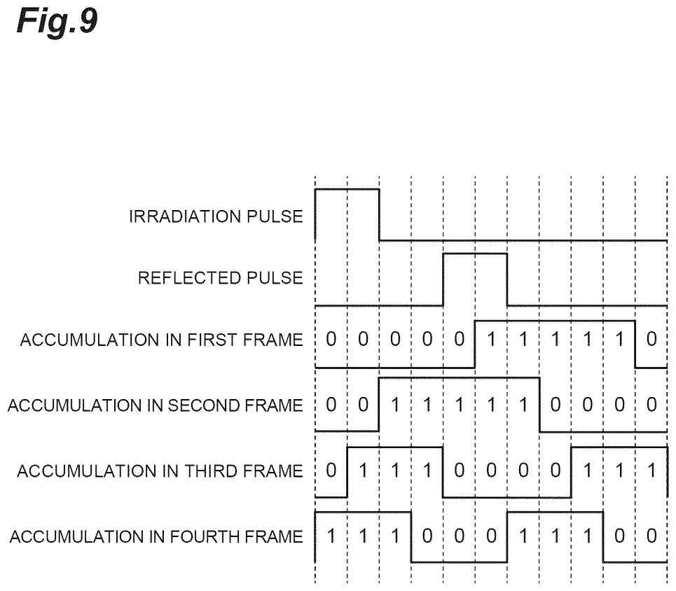

FIG. 9 to FIG. 15 are diagrams illustrating examples of the control pattern which satisfy the first to sixth conditions in the case in which k is an integer of 2 or more, and the pulse width P is set to more than k−1 times and k times or less the time T ((k−1)T<P≤kT).

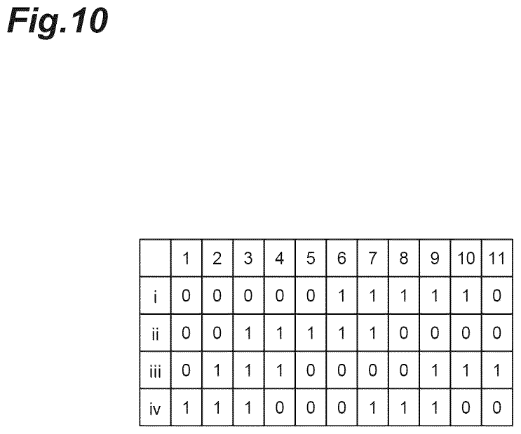

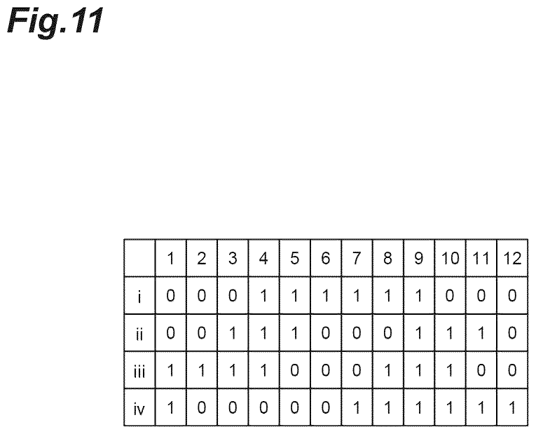

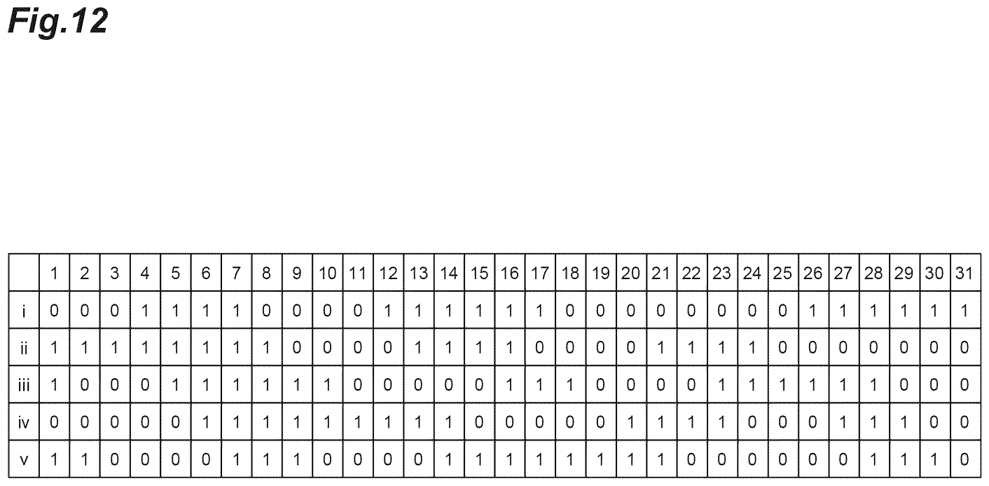

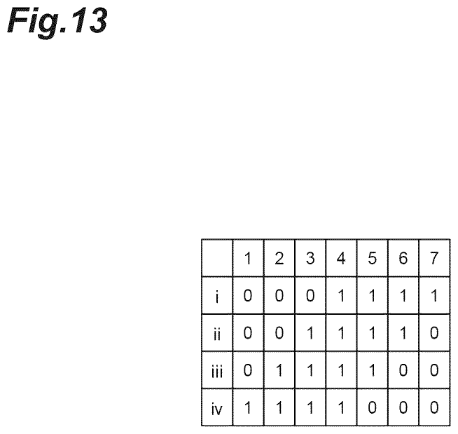

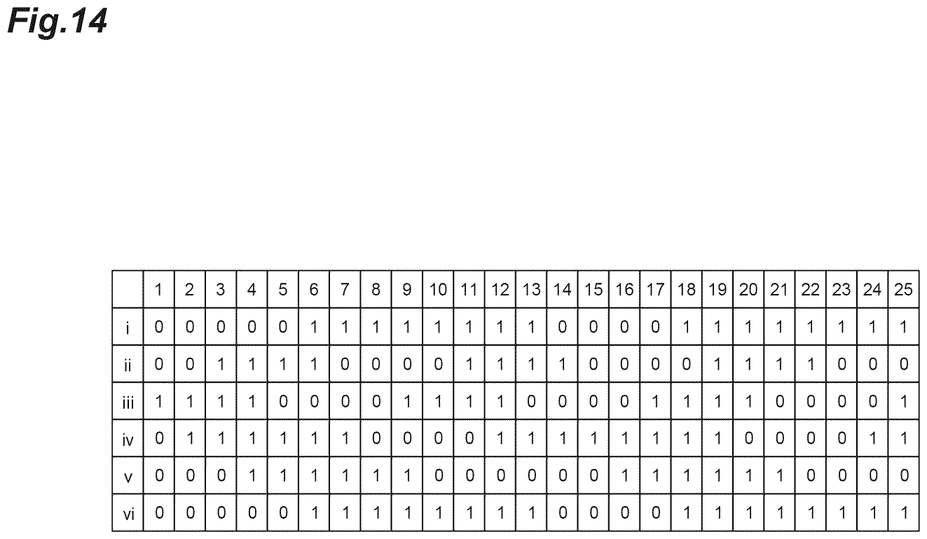

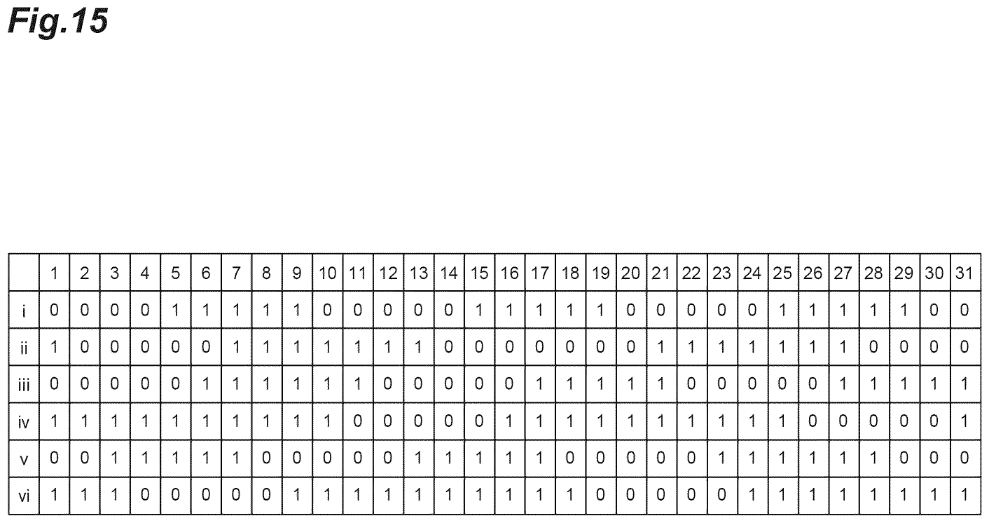

FIG. 9 is a diagram illustrating the control pattern in the waveform format in the case in which k=2, M=4, and N=11, with the waveforms of the irradiation light pulse and the reflected light pulse. FIG. 10 is a diagram illustrating the control pattern in the table format which is illustrated in the waveform format in FIG. 9. FIG. 11 is a diagram illustrating the control pattern in the table format in the case in which k=2, M=4, and N=12. FIG. 12 is a diagram illustrating the control pattern in the table format in the case in which k=2, M=5, and N=31. FIG. 13 is a diagram illustrating the control pattern in the table format in the case in which k=3, M=4, and N=7. FIG. 14 is a diagram illustrating the control pattern in the table format in the case in which k=3, M=6, and N=25. FIG. 15 is a diagram illustrating the control pattern in the table format in the case in which k=4, M=6, and N=31.

By applying the control pattern as described above to the light receiving unit 5, it is possible to reliably perform the distance measurement by the TOF method by using the compressive sensing technique.

In the case in which k is an integer of 2 or more, and the pulse width P is set to more than k−1 times and k times or less the time T ((k−1)T<P≤kT), the control pattern may be a control pattern in which the indication of the accumulation of the charges in the n-th period is repeated rₙ times for each of the M frames. In this case, it is preferable that the control pattern further satisfies the following seventh condition.

The seventh condition is that the same content as the above sixth condition is satisfied for the matrix of the M rows and the N columns in which the value of the element at the m-th row and the n-th column is set to rₙa_{m,n}. That is, the matrix Φᵣ of the M rows and the N columns in which the value of the element at the m-th row and the n-th column is set to rₙa_{m,n} is represented by the following Formula (9).

$$\begin{matrix}[ Formula 9 ] & \\ {Φ}_{r} = ( \begin{matrix}{r}_{1} {a}_{1 , 1} & … & {r}_{n} {a}_{1 , n} & … & {r}_{N} {a}_{1 , N} \\ ⋮ & ⋱ & & & ⋮ \\ {r}_{1} {a}_{m , 1} & & {r}_{n} {a}_{m , n} & & {r}_{N} {a}_{m , N} \\ ⋮ & & & ⋱ & ⋮ \\ {r}_{1} {a}_{M , 1} & … & {r}_{n} {a}_{M , n} & … & {r}_{N} {a}_{M , N}\end{matrix} ) & ( 9 )\end{matrix}$$

When the consecutive k+1 or less column vectors out of the N column vectors ϕ_{r,1} to ϕ_{r,N} (the following Formula (10)) forming the above matrix Φᵣ are set to ϕ_{r,n1} to ϕ_{r,n2}, the sum column vector S_{rA} which is the sum of the above column vectors ϕ_{r,n1} to ϕ_{r,n2} is represented by the following Formula (11). The column vector having the maximum value obtained by dividing the inner product of the sum column vector S_{rA} and each column vector ϕ_{r,n} by the magnitude of the column vector ϕ_{r,n} is any one of the column vectors ϕ_{r,n1} to ϕ_{r,n2}.

$$\begin{matrix}[ Formula 10 ] & \\ {ϕ}_{r , n} = ( \begin{matrix}{r}_{n} {a}_{1 , n} \\ ⋮ \\ {r}_{n} {a}_{m , n} \\ ⋮ \\ {r}_{n} {a}_{M , n}\end{matrix} ) & ( 10 )\end{matrix}$$

$$\begin{matrix}[ Formula 11 ] & \\ {S}_{A} = {\sum }_{n = n 1}^{n 2} {ϕ}_{r , n} = ( \begin{matrix}{\sum }_{n = n 1}^{n 2} {r}_{n} {a}_{1 , n} \\ ⋮ \\ {\sum }_{n = n 1}^{n 2} {r}_{n} {a}_{m , n} \\ ⋮ \\ {\sum }_{n = n 1}^{n 2} {r}_{n} {a}_{M , n}\end{matrix} ) & ( 11 )\end{matrix}$$

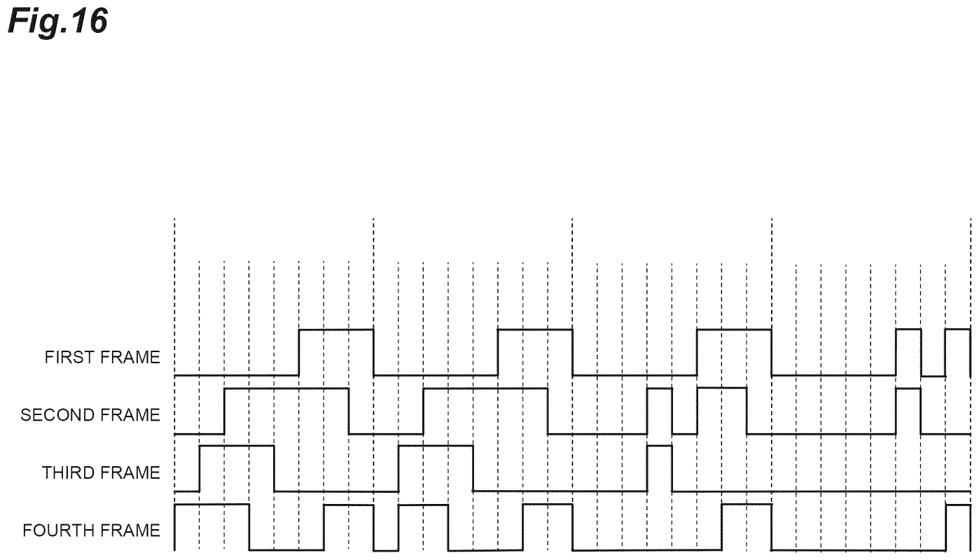

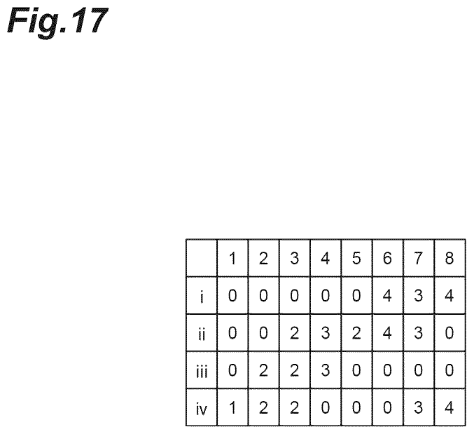

FIG. 16 and FIG. 17 are diagrams illustrating an example of the control pattern in which the number of charge accumulations r, is adjusted in the case in which M=4 and N=8.

FIG. 16 is a diagram illustrating the control pattern in the waveform format in the case in which the number of charge accumulations rₙ is adjusted. FIG. 17 is a diagram illustrating the control pattern in the table format which is illustrated in the waveform format in FIG. 16. The number in the diagram indicates the number of charge accumulations rₙ.

As described above, by making the number of accumulations different depending on the period of the charge accumulation for each of the M frames, it is possible to stably perform the distance measurement regardless of the distance to the object. That is, in general, the longer the distance to the object, the smaller the intensity of the reflected light pulse reaching the light receiving unit 5, and the worse the SN. Therefore, as the distance to the object is longer (that is, as the time from the light pulse output timing of the light source to the period of the charge accumulation is longer), the number of charge accumulations rₙ is set to be larger, and in this case, the distance measurement can be stably performed regardless of the distance to the object.

Further, in the case in which it is known in advance that the object having a small reflectance exists in the vicinity of a certain distance, by setting the number of charge accumulations rₙ to be larger for the period corresponding to the above distance, it is possible to stably perform the distance measurement even for the above object having the small reflectance. Further, by equally increasing the number of accumulations (for example, rₙ=1000) regardless of the period of the charge accumulation, the signal amount can be adjusted according to the intensity of the reflected light pulse.

As in the configuration of the light receiving unit 5 which is illustrated in FIG. 2, the light receiving unit 5 may include a plurality of charge accumulation portions for one photodiode. In this case, the control unit 6 can simultaneously apply, to the light receiving unit 5, a plurality of frames which do not simultaneously indicate the charge accumulation in the same period out of the M frames of the control pattern. In this case, the time required for the distance measurement can be shortened.

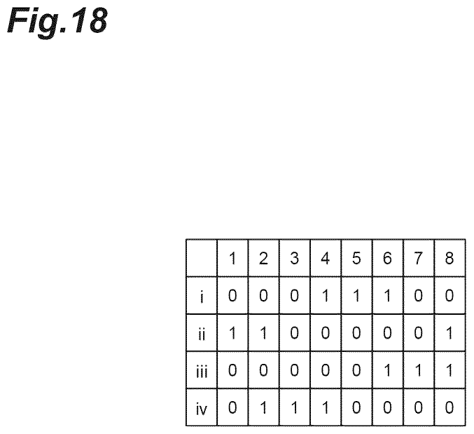

FIG. 18 is a diagram illustrating an example of the control pattern in the above case. In this example, in the configuration of the light receiving unit 5 illustrated in FIG. 2, the first frame out of the control pattern can be applied to the switch SW1, and at the same time, the second frame can be applied to the switch SW2. Further, the third frame out of the control pattern can be applied to the switch SW1, and at the same time, the fourth frame can be applied to the switch SW2. In addition, in the period in which the charge accumulation is not performed in all the plurality of frames which are simultaneously applied to the light receiving unit 5, the charges generated in the photodiode PD are removed to the charge removal portion.

Further, the light receiving unit 5 may include a plurality of sets of photodiodes and charge accumulation portions. In this case, the control unit 6 can simultaneously apply a plurality of frames out of the M frames of the control pattern to the light receiving unit 5. The plurality of frames which are simultaneously applied to the light receiving unit 5 may simultaneously indicate the charge accumulation in the same period. That is, a certain frame is applied to a certain set of the photodiode and the charge accumulation portion, and at the same time, another arbitrary frame is applied to another set. In this case also, the time required for the distance measurement can be shortened.

Next, the processing contents of the processing unit 7 will be described. A power of the reflected light reaching the light receiving unit 5 in the n-th period out of the N periods after the light pulse output timing of the light source is set to xₙ, and a column vector having x₁ to x_{N} as elements is set to x (the following Formula (12)). The amount of the charges accumulated in the charge accumulation portion of the light receiving unit 5 in the m-th frame out of the M frames of the control pattern is set to yₘ, and a column vector having y₁ to yₘ as elements is set to y (the following Formula (13)).

$$\begin{matrix}[ Formula 12 ] & \\ x = ( \begin{matrix}{x}_{1} \\ ⋮ \\ {x}_{n} \\ ⋮ \\ {x}_{N}\end{matrix} ) & ( 12 )\end{matrix}$$

$$\begin{matrix}[ Formula 13 ] & \\ y = ( \begin{matrix}{y}_{1} \\ ⋮ \\ {y}_{m} \\ ⋮ \\ {y}_{M}\end{matrix} ) & ( 13 )\end{matrix}$$

The matrix Φ (the above Formula (1)) of the M rows and the N columns representing the control pattern, the column vector x (Formula (12)), and the column vector y (Formula (13)) have a relationship represented by the following Formula (14).

$$\begin{matrix}[ Formula 14 ] & \\ y = Φ x & ( 14 )\end{matrix}$$

In the case in which it is set to M=N, and the inverse matrix Φ⁻¹ of the matrix Φ exists, x can be analytically determined by the following Formula (15). On the other hand, in the case in which it is set to M<N, x cannot be analytically determined.

$$\begin{matrix}[ Formula 15 ] & \\ x = {Φ}^{- 1} y & ( 15 )\end{matrix}$$

In this case, x can be determined by solving an optimization problem represented by the following Formula (16) by using an iterative method. A second term of this Formula is an L1 norm (sum of absolute values of respective elements). By solving this optimization problem, it is possible to determine x which satisfies the above condition with the number of measurements (the number of frames M) smaller than the unknown number (the number of periods N). However, in this optimization problem, a calculation amount is indefinite and a calculation time is long.

$$\begin{matrix}[ Formula 16 ] & \\ minimize \frac{1}{2} {‖ Φ x - y ‖}_{2}^{2} + λ {‖ x ‖}_{1} & ( 16 )\end{matrix}$$

It is preferable that x is determined by solving an optimization problem represented by the following Formula (17) by applying an orthogonal matching pursuit (OMP) algorithm. A second term of this Formula is an L0 norm (the number of elements having values of non-zero). In this case, the calculation time can be stabilized and shortened.

$$\begin{matrix}[ Formula 17 ] & \\ minimize \frac{1}{2} {‖ Φ x - y ‖}_{2}^{2} + λ {‖ x ‖}_{0} & ( 17 )\end{matrix}$$

A method of solving the L0 optimization problem (Formula (17)) by applying the OMP algorithm is as follows. First, the following Formula (18) is calculated for each of the N column vectors ϕ₁ to ϕ_{N} forming the matrix Φ, and the column vector ϕₙ₁ having the maximum calculated value is determined. In this Formula, a numerator represents the inner product of the column vector y and the column vector ϕₙ, and a denominator represents the magnitude of the column vector ϕₙ.

$$\begin{matrix}[ Formula 18 ] & \\ \frac{〈 {ϕ}_{n} , y 〉}{{‖ {ϕ}_{n} ‖}_{2}} & ( 18 )\end{matrix}$$

A matrix Φ_{S} of M rows and N columns including only the column vector ϕₙ₁ determined as described above (that is, the values of all the elements of the columns other than the n1-th column are zero) is created. Further, by using the above matrix Φ_{S}, a column vector x_{S} representing the least squares solution of x is calculated by using the following Formula (19), and a column vector r representing the residual error is calculated by using the following Formula (20).

$$\begin{matrix}[ Formula 19 ] & \\ {x}_{S} = {( {Φ}_{S}^{T} {Φ}_{S} )}^{- 1} {Φ}_{S}^{T} y & ( 19 )\end{matrix}$$

$$\begin{matrix}[ Formula 20 ] & \\ r = y - {Φ}_{S} {x}_{S} & ( 20 )\end{matrix}$$

Subsequently, the following Formula (21) is calculated for the column vector adjacent to the already determined column vector ϕₙ₁ out of the N column vectors ϕ₁ to ϕ_{N} forming the matrix Φ, and the column vector ϕₙ₂ having the maximum calculated value is determined. In this Formula, a numerator represents the inner product of the column vector r and the column vector ϕₙ, and a denominator represents the magnitude of the column vector ϕₙ.

$$\begin{matrix}[ Formula 21 ] & \\ \frac{〈 {ϕ}_{n} , r 〉}{{‖ {ϕ}_{n} ‖}_{2}} & ( 21 )\end{matrix}$$

The matrix Φ_{S} including only the column vectors ϕₙ₁ and ϕₙ₂ determined as described above is updated. Further, by using the above matrix Φ_{S}, the column vector x_{S} representing the least squares solution of x is calculated by using the above Formula (19), and the column vector r representing the residual error is updated by using the above Formula (20). The above processing is repeatedly performed.

The above repeated processing is performed until the magnitude of the column vector r representing the residual error becomes the predetermined value or less, or until the number of column vectors which are determined by the calculation of Formula (18) or Formula (21) becomes k+1.

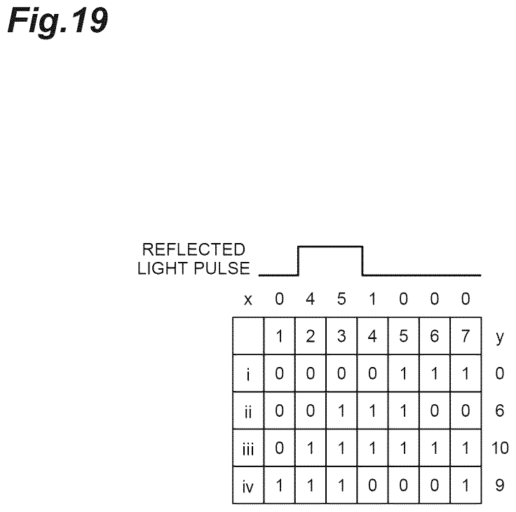

FIG. 19 is a diagram illustrating an example of solving the L0 optimization problem by applying the OMP algorithm. This diagram illustrates the control pattern in the table format in the case in which k=2, M=4, and N=7, and also illustrates the values of the respective elements of the column vector x and the column vector y.

In this example, when Formula (18) is calculated for each of the seven column vectors ϕ₁ to ϕ₇ forming the matrix Φ of the four rows and the seven columns, the column vector ϕ₃ has the maximum calculated value. The column vector x_{S}=(0, 0, 8.3, 0, 0, 0, 0)^{T} representing the least squares solution of x is acquired by using Formula (19), and further, the column vector r=(0, −2.3, 1.7, 0.7)^{T} representing the residual error is acquired by using Formula (20).

Subsequently, when Formula (21) is calculated for each of the two column vectors ϕ₂ and ϕ₄ adjacent to the column vector ϕ₃ which is determined as described above, the column vector ϕ₂ has the maximum calculated value. The column vector x_{S}=(0, 3.5, 6, 0, 0, 0, 0)^{T} representing the least squares solution of x is acquired by using Formula (19), and the column vector r=(0, 0, 0.5, −0.5)^{T} representing the residual error is acquired by using Formula (20).

Further, subsequently, when Formula (21) is calculated for each of the two column vectors ϕ₁ and ϕ₄ adjacent to the column vectors ϕ₂ and ϕ₃ which are determined as described above, the column vector ϕ₄ has the maximum calculated value. The column vector x_{S}=(0, 4, 5, 1, 0, 0, 0)^{T} representing the least squares solution of x is acquired by using Formula (19), and the column vector r=(0, 0, 0, 0)^{T} representing the residual error is acquired by using Formula (20).

The column vector x_{S} representing the least squares solution of x obtained after the repeated processing is performed three times (=k+1 times) coincides with the column vector x. Further, the magnitude of the column vector r representing the residual error at this time is 0.

As described above, by solving the L0 optimization problem by applying the OMP algorithm, the calculation time can be stabilized and shortened. Further, as a result of the above, the operation power and the power consumption required from the required specification can be minimized.

In addition, the background light is incident on the light receiving unit 5 in addition to the reflected light pulse. In this case, it is preferable that the processing unit 7 performs correction based on the background light intensity at the time of determining the distance to the object.

In order to reduce the influence of the background light, the signal value acquired at the time of the reflected light pulse measurement may be corrected by using hardware or software, based on the amount of the charges accumulated in the charge accumulation portion or the charge removal portion in a period in which only the background light is incident on the light receiving unit 5 (a period in which the light pulse is not output from the light source before or after the time of the reflected light pulse measurement, or a period in which the reflected light pulse is not incident on the light receiving unit 5 even at the time of the reflected light pulse measurement). Further, the signal value acquired at the time of the reflected light pulse measurement can be corrected also by creating the matrix Φ in consideration of the background light intensity.

The distance measurement apparatus and the distance measurement method are not limited to the embodiments and configuration examples described above, and various modifications are possible.

The distance measurement apparatus of a first aspect according to the above embodiment includes (1) a light source for irradiating an object with a light pulse having a pulse width P; (2) a light receiving unit including a photodiode for receiving the light pulse with which the object is irradiated from the light source and reflected by the object to generate charges, and a charge accumulation portion for accumulating the charges generated in the photodiode; (3) a control unit for applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing unit for determining a distance to the object by using a compressive sensing technique based on an amount of the charges accumulated by the charge accumulation portion, and the apparatus is configured to measure the distance to the object by using a time of flight method, the pulse width P is set to the predetermined time T or less, and in the control unit, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, and a Hamming distance is 1 for all combinations of two column vectors adjacent to each other out of the N column vectors, is applied to the light receiving unit.

In the distance measurement apparatus of a second aspect, in the configuration of the first aspect, the control unit may apply, to the light receiving unit, the control pattern in which an indication of the accumulation of the charges in the n-th period is repeated rₙ times for each of the M frames.

In the distance measurement apparatus of a third aspect, in the configuration of the second aspect, the control unit may apply, to the light receiving unit, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors.

The distance measurement apparatus of a fourth aspect according to the above embodiment includes (1) a light source for irradiating an object with a light pulse having a pulse width P; (2) a light receiving unit including a photodiode for receiving the light pulse with which the object is irradiated from the light source and reflected by the object to generate charges, and a charge accumulation portion for accumulating the charges generated in the photodiode; (3) a control unit for applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing unit for determining a distance to the object by using a compressive sensing technique based on an amount of the charges accumulated by the charge accumulation portion, and the apparatus is configured to measure the distance to the object by using a time of flight method, the pulse width P is set to more than k−1 times and k times or less the predetermined time T (k is an integer of 2 or more), and in the control unit, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, a Hamming distance is 1 for all combinations of two column vectors adjacent to each other out of the N column vectors, a Hamming distance is k or more for all combinations of two column vectors separated from each other by k+1 columns out of the N column vectors, and for all combinations of consecutive k+1 column vectors out of the N column vectors, in a matrix of M rows and k+1 columns formed by the k+1 column vectors, there are k+1 or more row vectors different from each other and in which a value of at least one element is 1 out of M row vectors, is applied to the light receiving unit.

In the distance measurement apparatus of a fifth aspect, in the configuration of the fourth aspect, the control unit may apply, to the light receiving unit, the control pattern in which an indication of the accumulation of the charges in the n-th period is repeated rₙ times for each of the M frames.

In the distance measurement apparatus of a sixth aspect, in the configuration of the fifth aspect, the control unit may apply, to the light receiving unit, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors.

In the distance measurement apparatus of a seventh aspect, in the configuration of any one of the first to sixth aspects, the light receiving unit may include one photodiode and a plurality of charge accumulation portions as the photodiode and the charge accumulation portion, and the control unit may simultaneously apply, to the light receiving unit, a plurality of frames which do not simultaneously indicate charge accumulation in a same period out of the M frames of the control pattern.

In the distance measurement apparatus of an eighth aspect, in the configuration of any one of the first to sixth aspects, the light receiving unit may include a plurality of sets of photodiodes and charge accumulation portions as the photodiode and the charge accumulation portion, and the control unit may simultaneously apply, to the light receiving unit, a plurality of frames out of the M frames of the control pattern.

In the distance measurement apparatus of a ninth aspect, in the configuration of any one of the first to eighth aspects, the processing unit may determine the distance to the object by using an orthogonal matching pursuit algorithm.

In the distance measurement apparatus of a tenth aspect, in the configuration of any one of the first to ninth aspects, the processing unit may perform correction based on a background light intensity when determining the distance to the object.

In the distance measurement apparatus of an eleventh aspect, in the configuration of any one of the first to tenth aspects, the apparatus may further include an imaging optical system for inputting and forming an image of the light pulse with which the object is irradiated from the light source and reflected by the object, and in the light receiving unit, a plurality of pixels each including the photodiode and the charge accumulation portion may be arrayed two-dimensionally on a light receiving surface for receiving the light pulse passed through the imaging optical system, and the processing unit may acquire a distance image of the object by determining the distance to the object for each of the plurality of pixels.

The distance measurement method of a first aspect according to the above embodiment is a method using (1) a light source for irradiating an object with a light pulse having a pulse width P; and (2) a light receiving unit including a photodiode for receiving the light pulse with which the object is irradiated from the light source and reflected by the object to generate charges, and a charge accumulation portion for accumulating the charges generated in the photodiode, the method for measuring a distance to the object by using a time of flight method, and the method includes (3) a control step of applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing step of determining the distance to the object by using a compressive sensing technique based on an amount of the charges accumulated by the charge accumulation portion, and the pulse width P is set to the predetermined time T or less, and in the control step, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, and a Hamming distance is 1 for all combinations of two column vectors adjacent to each other out of the N column vectors, is applied to the light receiving unit.

In the distance measurement method of a second aspect, in the configuration of the first aspect, in the control step, the control pattern in which an indication of the accumulation of the charges in the n-th period is repeated rₙ times for each of the M frames may be applied to the light receiving unit.

In the distance measurement method of a third aspect, in the configuration of the second aspect, in the control step, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors may be applied to the light receiving unit.

The distance measurement method of a fourth aspect according to the above embodiment is a method using (1) a light source for irradiating an object with a light pulse having a pulse width P; and (2) a light receiving unit including a photodiode for receiving the light pulse with which the object is irradiated from the light source and reflected by the object to generate charges, and a charge accumulation portion for accumulating the charges generated in the photodiode, the method for measuring a distance to the object by using a time of flight method, and the method includes (3) a control step of applying, to the light receiving unit, a control pattern including M frames indicating whether or not to transfer and accumulate the charges generated in the photodiode to the charge accumulation portion in each of N periods divided by a predetermined time T from a light pulse output timing of the light source; and (4) a processing step of determining the distance to the object by using a compressive sensing technique based on an amount of the charges accumulated by the charge accumulation portion, and the pulse width P is set to more than k−1 times and k times or less the predetermined time T (k is an integer of 2 or more), and in the control step, when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated, the control pattern in which a value of at least one element is 1 for all N column vectors forming the matrix of the M rows and the N columns, all the N column vectors are different from each other, a Hamming distance is 1 for all combinations of two column vectors adjacent to each other out of the N column vectors, a Hamming distance is k or more for all combinations of two column vectors separated from each other by k+1 columns out of the N column vectors, and for all combinations of consecutive k+1 column vectors out of the N column vectors, in a matrix of M rows and k+1 columns formed by the k+1 column vectors, there are k+1 or more row vectors different from each other and in which a value of at least one element is 1 out of M row vectors, is applied to the light receiving unit.

In the distance measurement method of a fifth aspect, in the configuration of the fourth aspect, in the control step, the control pattern in which an indication of the accumulation of the charges in the n-th period is repeated rₙ times for each of the M frames may be applied to the light receiving unit.

In the distance measurement method of a sixth aspect, in the configuration of the fifth aspect, in the control step, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors may be applied to the light receiving unit.

In the distance measurement method of a seventh aspect, in the configuration of any one of the first to sixth aspects, the light receiving unit may include one photodiode and a plurality of charge accumulation portions as the photodiode and the charge accumulation portion, and in the control step, a plurality of frames which do not simultaneously indicate charge accumulation in a same period out of the M frames of the control pattern may be simultaneously applied to the light receiving unit.

In the distance measurement method of an eighth aspect, in the configuration of any one of the first to sixth aspects, the light receiving unit may include a plurality of sets of photodiodes and charge accumulation portions as the photodiode and the charge accumulation portion, and in the control step, a plurality of frames out of the M frames of the control pattern may be simultaneously applied to the light receiving unit.

In the distance measurement method of a ninth aspect, in the configuration of any one of the first to eighth aspects, in the processing step, the distance to the object may be determined by using an orthogonal matching pursuit algorithm.

In the distance measurement method of a tenth aspect, in the configuration of any one of the first to ninth aspects, in the processing step, correction based on a background light intensity may be performed when determining the distance to the object.

In the distance measurement method of an eleventh aspect, in the configuration of any one of the first to tenth aspects, the method may further use an imaging optical system for inputting and forming an image of the light pulse with which the object is irradiated from the light source and reflected by the object, and in the light receiving unit, a plurality of pixels each including the photodiode and the charge accumulation portion may be arrayed two-dimensionally on a light receiving surface for receiving the light pulse passed through the imaging optical system, and in the processing step, a distance image of the object may be acquired by determining the distance to the object for each of the plurality of pixels.

### INDUSTRIAL APPLICABILITY

The embodiments can be used as an apparatus and a method capable of reliably performing distance measurement by a TOF method using a compressive sensing technique.

The distance measurement apparatus or the distance measurement method of the above embodiment may be used in application fields such as 3D face recognition, AR, in-vehicle application, monitoring camera, and robot picking. In the above applications, in the techniques of the 3D face recognition and the AR, the distance measurement apparatus may be provided in a mobile terminal device, and further, in the in-vehicle application, the distance measurement apparatus may be used for the distance measurement with the object necessary for an autonomous driving technology.

### REFERENCE SIGNS LIST

1—distance measurement apparatus, 2—light source, 3—irradiation optical system, 4—focusing optical system, 5—light receiving unit, 6—control unit, 7—processing unit.

1. A distance measurement apparatus comprising:
a light source configured to irradiate an object with a light pulse having a pulse width P;
a light receiving unit including a photodiode configured to receive the light pulse with which the object is irradiated from the light source and reflected by the object to generate charges, and a charge accumulation portion configured to accumulate the charges generated in the photodiode;
a controller configured to apply, to the light receiving unit, a control pattern including M frames indicating whether or not to transfer and accumulate the charges generated in the photodiode to the charge accumulation portion in each of N periods divided by a predetermined time T from a light pulse output timing of the light source; and
a processor configured to determine a distance to the object by using a compressive sensing technique based on an amount of the charges accumulated by the charge accumulation portion, wherein
the apparatus is configured to measure the distance to the object by using a time of flight method,
the pulse width P is set to the predetermined time T or less, and
in the controller,
when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated,
the control pattern in which a value of at least one element is 1 for all N column vectors forming the matrix of the M rows and the N columns, all the N column vectors are different from each other, and a Hamming distance is 1 for all combinations of two column vectors adjacent to each other out of the N column vectors, is applied to the light receiving unit.

2. The distance measurement apparatus according to claim 1, wherein the controller is configured to apply, to the light receiving unit, the control pattern in which an indication of the accumulation of the charges in the n-th period is repeated rₙ times for each of the M frames.

3. The distance measurement apparatus according to claim 2, wherein the controller is configured to apply, to the light receiving unit, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors.

4. A distance measurement apparatus comprising:
a light source configured to irradiate an object with a light pulse having a pulse width P;
a light receiving unit including a photodiode configured to receive the light pulse with which the object is irradiated from the light source and reflected by the object to generate charges, and a charge accumulation portion configured to accumulate the charges generated in the photodiode;
a controller configured to apply, to the light receiving unit, a control pattern including M frames indicating whether or not to transfer and accumulate the charges generated in the photodiode to the charge accumulation portion in each of N periods divided by a predetermined time T from a light pulse output timing of the light source; and
a processor configured to determine a distance to the object by using a compressive sensing technique based on an amount of the charges accumulated by the charge accumulation portion, wherein
the apparatus is configured to measure the distance to the object by using a time of flight method,
the pulse width P is set to more than k−1 times and k times or less the predetermined time T (k is an integer of 2 or more), and
in the controller,
when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated,
the control pattern in which a value of at least one element is 1 for all N column vectors forming the matrix of the M rows and the N columns, all the N column vectors are different from each other, a Hamming distance is 1 for all combinations of two column vectors adjacent to each other out of the N column vectors, a Hamming distance is k or more for all combinations of two column vectors separated from each other by k+1 columns out of the N column vectors, and for all combinations of consecutive k+1 column vectors out of the N column vectors, in a matrix of M rows and k+1 columns formed by the k+1 column vectors, there are k+1 or more row vectors different from each other and in which a value of at least one element is 1 out of M row vectors, is applied to the light receiving unit.

5. The distance measurement apparatus according to claim 4, wherein the controller is configured to apply, to the light receiving unit, the control pattern in which an indication of the accumulation of the charges in the n-th period is repeated rₙ times for each of the M frames.

6. The distance measurement apparatus according to claim 5, wherein the controller is configured to apply, to the light receiving unit, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors.

7. The distance measurement apparatus according to claim 1, wherein the light receiving unit includes one photodiode and a plurality of charge accumulation portions as the photodiode and the charge accumulation portion, and
the controller is configured to simultaneously apply, to the light receiving unit, a plurality of frames which do not simultaneously indicate charge accumulation in a same period out of the M frames of the control pattern.

8. The distance measurement apparatus according to claim 1, wherein the light receiving unit includes a plurality of sets of photodiodes and charge accumulation portions as the photodiode and the charge accumulation portion, and
the controller is configured to simultaneously apply, to the light receiving unit, a plurality of frames out of the M frames of the control pattern.

9. The distance measurement apparatus according to claim 1, wherein the processing unit determines processor is configured to determine the distance to the object by using an orthogonal matching pursuit algorithm.

10. The distance measurement apparatus according to claim 1, wherein the processor is configured to perform correction based on a background light intensity when determining the distance to the object.

11. The distance measurement apparatus according to claim 1, further comprising an imaging optical system for inputting configured to input and form an image of the light pulse with which the object is irradiated from the light source and reflected by the object, wherein
in the light receiving unit, a plurality of pixels each including the photodiode and the charge accumulation portion are arrayed two-dimensionally on a light receiving surface configured to receive the light pulse passed through the imaging optical system, and
the processor is configured to acquire a distance image of the object by determining the distance to the object for each of the plurality of pixels.

12. A distance measurement method using:
a light source configured to irradiate an object with a light pulse having a pulse width P; and
a light receiving unit including a photodiode configured to receive the light pulse with which the object is irradiated from the light source and reflected by the object to generate charges, and a charge accumulation portion configured to accumulate the charges generated in the photodiode,
the method for measuring a distance to the object by using a time of flight method, comprising:
performing a control of applying, to the light receiving unit, a control pattern including M frames indicating whether or not to transfer and accumulate the charges generated in the photodiode to the charge accumulation portion in each of N periods divided by a predetermined time T from a light pulse output timing of the light source; and
performing a processing of determining the distance to the object by using a compressive sensing technique based on an amount of the charges accumulated by the charge accumulation portion, wherein
the pulse width P is set to the predetermined time T or less, and
in the control,
when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated,
the control pattern in which a value of at least one element is 1 for all N column vectors forming the matrix of the M rows and the N columns, all the N column vectors are different from each other, and a Hamming distance is 1 for all combinations of two column vectors adjacent to each other out of the N column vectors, is applied to the light receiving unit.

13. The distance measurement method according to claim 12, wherein in the control, the control pattern in which an indication of the accumulation of the charges in the n-th period is repeated rₙ times for each of the M frames is applied to the light receiving unit.

14. The distance measurement method according to claim 13, wherein in the control, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors is applied to the light receiving unit.

15. A distance measurement method using:
a light source configured to irradiate an object with a light pulse having a pulse width P; and
a light receiving unit including a photodiode configured to receive the light pulse with which the object is irradiated from the light source and reflected by the object to generate charges, and a charge accumulation portion configured to accumulate the charges generated in the photodiode,
the method for measuring a distance to the object by using a time of flight method, comprising:
performing a control of applying, to the light receiving unit, a control pattern including M frames indicating whether or not to transfer and accumulate the charges generated in the photodiode to the charge accumulation portion in each of N periods divided by a predetermined time T from a light pulse output timing of the light source; and
performing a processing of determining the distance to the object by using a compressive sensing technique based on an amount of the charges accumulated by the charge accumulation portion, wherein
the pulse width P is set to more than k−1 times and k times or less the predetermined time T (k is an integer of 2 or more), and
in the control,
when the control pattern is represented by a matrix of M rows and N columns, and a value a_{m,n} of an element at an m-th row and an n-th column of the matrix of the M rows and the N columns is set to 1 when accumulation of the charges in the charge accumulation portion is indicated in an n-th period out of the N periods in an m-th frame out of the M frames, and is set to 0 when non-accumulation is indicated,
the control pattern in which a value of at least one element is 1 for all N column vectors forming the matrix of the M rows and the N columns, all the N column vectors are different from each other, a Hamming distance is 1 for all combinations of two column vectors adjacent to each other out of the N column vectors, a Hamming distance is k or more for all combinations of two column vectors separated from each other by k+1 columns out of the N column vectors, and for all combinations of consecutive k+1 column vectors out of the N column vectors, in a matrix of M rows and k+1 columns formed by the k+1 column vectors, there are k+1 or more row vectors different from each other and in which a value of at least one element is 1 out of M row vectors, is applied to the light receiving unit.

16. The distance measurement method according to claim 15, wherein in the control, the control pattern in which an indication of the accumulation of the charges in the n-th period is repeated rₙ times for each of the M frames is applied to the light receiving unit.

17. The distance measurement method according to claim 16, wherein in the control, the control pattern in which, for all combinations of consecutive k+1 or less column vectors out of the N column vectors forming the matrix of the M rows and the N columns in which the value of the element at the m-th row and the n-th column is set to rₙa_{m,n}, a column vector in which a value obtained by dividing an inner product of a sum column vector, which is a sum of the k+1 or less column vectors, and each of the N column vectors by a magnitude of the column vector is a maximum value is any one of the k+1 or less column vectors is applied to the light receiving unit.

18. The distance measurement method according to claim 12, wherein the light receiving unit includes one photodiode and a plurality of charge accumulation portions as the photodiode and the charge accumulation portion, and
in the control, a plurality of frames which do not simultaneously indicate charge accumulation in a same period out of the M frames of the control pattern are simultaneously applied to the light receiving unit.

19. The distance measurement method according to claim 12, wherein the light receiving unit includes a plurality of sets of photodiodes and charge accumulation portions as the photodiode and the charge accumulation portion, and
in the control, a plurality of frames out of the M frames of the control pattern are simultaneously applied to the light receiving unit.

20. The distance measurement method according to claim 12, wherein in the processing, the distance to the object is determined by using an orthogonal matching pursuit algorithm.

21. The distance measurement method according to claim 12, wherein in the processing, correction based on a background light intensity is performed when determining the distance to the object.

22. The distance measurement method according to claim 12, further using an imaging optical system configured to input and form an image of the light pulse with which the object is irradiated from the light source and reflected by the object, wherein
in the light receiving unit, a plurality of pixels each including the photodiode and the charge accumulation portion are arrayed two-dimensionally on a light receiving surface configured to receive the light pulse passed through the imaging optical system, and
in the processing, a distance image of the object is acquired by determining the distance to the object for each of the plurality of pixels.

23. The distance measurement apparatus according to claim 4, wherein the light receiving unit includes one photodiode and a plurality of charge accumulation portions as the photodiode and the charge accumulation portion, and
the controller is configured to simultaneously apply, to the light receiving unit, a plurality of frames which do not simultaneously indicate charge accumulation in a same period out of the M frames of the control pattern.

24. The distance measurement apparatus according to claim 4, wherein the light receiving unit includes a plurality of sets of photodiodes and charge accumulation portions as the photodiode and the charge accumulation portion, and
the controller is configured to simultaneously apply, to the light receiving unit, a plurality of frames out of the M frames of the control pattern.

25. The distance measurement apparatus according to claim 4, wherein the processor is configured to determine the distance to the object by using an orthogonal matching pursuit algorithm.

26. The distance measurement apparatus according to claim 4, wherein the processor is configured to perform correction based on a background light intensity when determining the distance to the object.

27. The distance measurement apparatus according to claim 4, further comprising an imaging optical system configured to input and form an image of the light pulse with which the object is irradiated from the light source and reflected by the object, wherein
in the light receiving unit, a plurality of pixels each including the photodiode and the charge accumulation portion are arrayed two-dimensionally on a light receiving surface configured to receive the light pulse passed through the imaging optical system, and
the processor is configured to acquire a distance image of the object by determining the distance to the object for each of the plurality of pixels.

28. The distance measurement method according to claim 15, wherein the light receiving unit includes one photodiode and a plurality of charge accumulation portions as the photodiode and the charge accumulation portion, and
in the control, a plurality of frames which do not simultaneously indicate charge accumulation in a same period out of the M frames of the control pattern are simultaneously applied to the light receiving unit.

29. The distance measurement method according to claim 15, wherein the light receiving unit includes a plurality of sets of photodiodes and charge accumulation portions as the photodiode and the charge accumulation portion, and
in the control, a plurality of frames out of the M frames of the control pattern are simultaneously applied to the light receiving unit.

30. The distance measurement method according to claim 15, wherein in the processing, the distance to the object is determined by using an orthogonal matching pursuit algorithm.

31. The distance measurement method according to claim 15, wherein in the processing, correction based on a background light intensity is performed when determining the distance to the object.

32. The distance measurement method according to claim 15, further using an imaging optical system configured to input and form an image of the light pulse with which the object is irradiated from the light source and reflected by the object, wherein
in the light receiving unit, a plurality of pixels each including the photodiode and the charge accumulation portion are arrayed two-dimensionally on a light receiving surface configured to receive the light pulse passed through the imaging optical system, and
in the processing, a distance image of the object is acquired by determining the distance to the object for each of the plurality of pixels.
